(19) United States
(12) Patent Application Publication
(10) Pub. No.: US 2018/0046022 A1
(43) Pub. Date: Feb. 15, 2018

(54) LIQUID CRYSTAL DISPLAY

(71) Applicant: Ortus Technology Co., Ltd., Hino (JP)

(72) Inventors: Hidehiro MORITA, Hino (JP); Ryota MIZUSAKO, Hino (JP); Norihiro ARAI, Hino (JP)

(73) Assignee: Ortus Technology Co., Ltd., Hino (JP)

(21) Appl. No.: 15/794,772

(22) Filed: Oct. 26, 2017

Related U.S. Application Data
(63) Continuation of application No. PCT/JP2016/062398, filed on Apr. 19, 2016.

(30) Foreign Application Priority Data
May 13, 2015 (JP) 2015-098257

(51) Int. Cl. G02F 1/1335; G02F 1/017

(52) U.S. Cl. CPC G02F 1/133528; G02F 1/017; G02F 1/1336; G02F 2001/133614; G02F 2001/01791; G02F 2001/133531; G02F 2001/133541

(57) ABSTRACT

A liquid crystal display includes: a light source unit which emits blue light; a first substrate opposed to the light source unit; a second substrate arranged to face the first substrate; a liquid crystal layer provided between the first substrate and the second substrate; and a wavelength conversion unit provided on the second substrate, controlling a wavelength of blue light having passed through the liquid crystal layer, and including quantum dots.

### CROSS-REFERENCE TO RELATED APPLICATIONS

This application is a Continuation Application of PCT Application No. PCT/JP2016/062398, filed Apr. 19, 2016, and based upon and claiming the benefit of priority from Japanese Patent Application No. 2015-098257, filed May 13, 2015, the entire contents of all of which are incorporated herein by reference.

### BACKGROUND OF THE INVENTION

### 1. Field of the Invention

The present invention relates to a liquid crystal display.

### 2. Description of the Related Art

A liquid crystal display is widely used as the display of various types of electronic devices, such as a television set, a personal computer, a mobile phone, a smartphone and a tablet terminal.

The liquid crystal display performs color display by causing light transmitting through a liquid crystal layer to pass through a color filter. When the light from the liquid crystal layer passes through the color filter, however, the intensity of the transmission light decreases. As a result, optical loss is generated.

The liquid crystal display controls the polarization of incident light and emitted light by employing two polarizers. When light is transmitting through the two polarizers, the intensity of the transmission light also decreases.

### BRIEF SUMMARY OF THE INVENTION

According to an aspect of the present invention, there is provided a liquid crystal display comprising:

a light source unit which emits blue light;

a first substrate opposed to the light source unit;

a second substrate arranged to face the first substrate;

a liquid crystal layer provided between the first substrate and the second substrate; and

a wavelength conversion unit provided on the second substrate, controlling a wavelength of blue light having passed through the liquid crystal layer, and including quantum dots.

### BRIEF DESCRIPTION OF THE SEVERAL VIEWS OF THE DRAWINGS

FIG. 1 is a schematic diagram illustrating the principle of a quantum dot.

FIG. 2 is a graph showing the wave function φ(x) according to the present embodiment.

FIG. 3 is a view illustrating how the waveform of incident light is converted in accordance with the diameter of a quantum dot.

FIG. 4 is a graph illustrating the relationship between the diameter of a quantum dot and the wavelength λ of light.

FIG. 5 is a graph illustrating the relationship between the diameter of a quantum dot and the wavelength λ of light.

FIG. 6 is a sectional view of a liquid crystal display according to the first embodiment.

FIG. 7 is a view illustrating an operation of the liquid crystal display of the first embodiment.

FIG. 8 is a sectional view of the liquid crystal display according to the second embodiment.

FIG. 9 is a view illustrating an operation of the liquid crystal display of the second embodiment.

### DETAILED DESCRIPTION OF THE INVENTION

A description will now be given of the embodiments with reference to the accompanying drawings. It should be noted that the drawings are schematic or conceptual, and the dimensions and scales of the drawings are not necessarily the same as the actual products. Where the same portion is depicted in different drawings, the dimensions and scale of one drawing may be different from those of another. Several embodiments described below merely show exemplary apparatuses and methods that implement the technical ideas of the present invention. The technical ideas are not limited by the element shapes, structures, arrangements etc. described below. In the description below, structural elements having substantially the same functions and configurations will be denoted by the same reference symbols, and a repetitive description of such elements will be given only where necessary.

### First Embodiment

### [1] Principle of Quantum Dot

The present embodiment realizes a liquid crystal display by utilizing a quantum dot. First, the principle of the quantum dot will be described.

The quantum dot is a semiconductor particle having a predetermined size and exhibiting the quantum confinement effect. In other words, the quantum dot confines carriers (electrons and electron holes) to a micro area inside a semiconductor material.

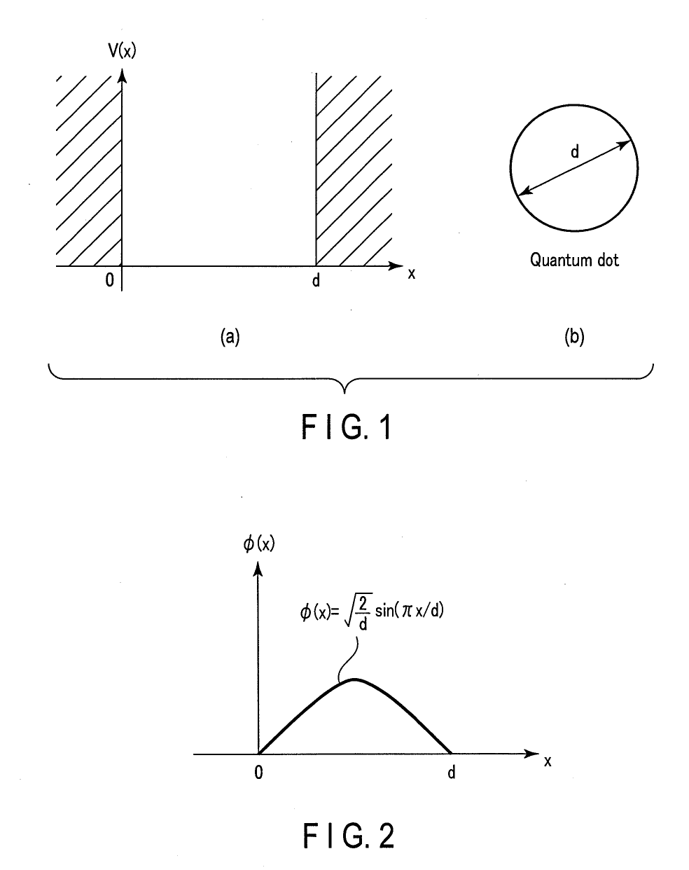

FIG. 1 is a schematic diagram illustrating the principle of the quantum dot. Consideration will be given of a particle of mass moving with the potential V(x) denoted by the following formula (1):

V(x)=0(0≦x≦d), and V(x)=∞(x<0, x>d) (1)

In formula (1), free particles are present in the range 0≦x≦d, and no particle is present in the ranges x<0 and x>d. Formula (1) can be represented by the potential well shown in FIG. 1(a). Electrons are confined within the distance 0≦x≦d, and a quantum dot having diameter d is defined in a simplified manner, as shown in FIG. 1(b).

By solving the Schrodinger equation using formula (1), the wave function φ(x) and the energy E are represented by the following formulas (2) and (3):

φ(x)=(2/d)^{1/2} sin(π×/d) (2)

E=h²/8md² (3)

where m is the mass of a particle, and h is a Planck constant.

FIG. 2 is a graph showing the wave function φ(x) expressed by formula (2). The energy of light is expressed by formula (4) below, using wavelength λ.

E=hc/λ (4)

where c is the speed of light.

By substituting formula (4) into formula (3), the wavelength λ can be represented by formula (5) below.

λ=8mcd²/h (5)

From formula (5), it can be understood that the wavelength λ of light is proportional to the square of the diameter d of a particle (quantum dot).

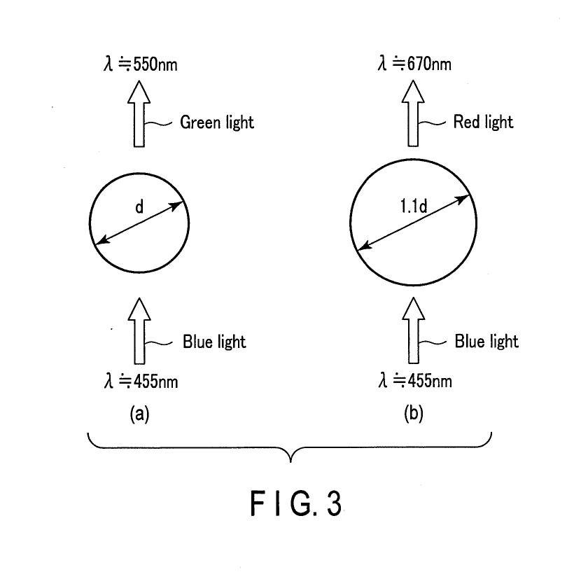

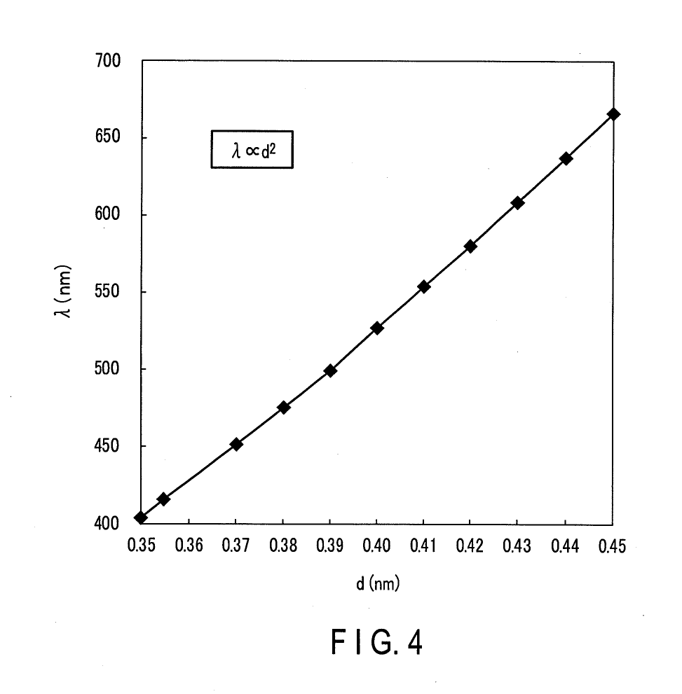

A description will be given of how the waveform conversion of light is performed using a quantum dot. FIG. 3 is a view illustrating how the waveform of incident light is converted in accordance with the diameter d of the quantum dot. FIG. 4 is a graph illustrating the relationship between the diameter of the quantum dot and the wavelength λ of light.

Let it be assumed that blue light whose wavelength λ is 455 nm or so is incident on the quantum dot. The blue light can be emitted from a light-emitting diode (LED) or a laser.

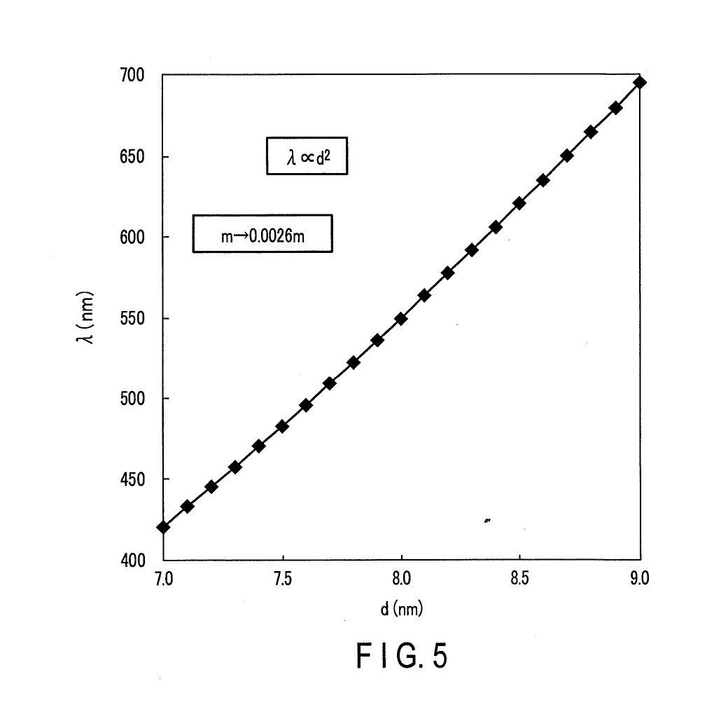

The blue light can be converted into light whose wavelength λ is nearly equal to 550 nm (d=0.41 nm) or 670 nm (d=0.45 nm) in accordance with the diameter d of the quantum dot. FIG. 4 is a graph showing the case where m is the mass (effective mass) of an electron. For example, where m is set to be smaller than the mass of an electron (m→0.0026 m), the relationship between the diameter d of the quantum dot and the wavelength λ of light is as shown in the graph in FIG. 5.

### [2] Structure of Liquid Crystal Display

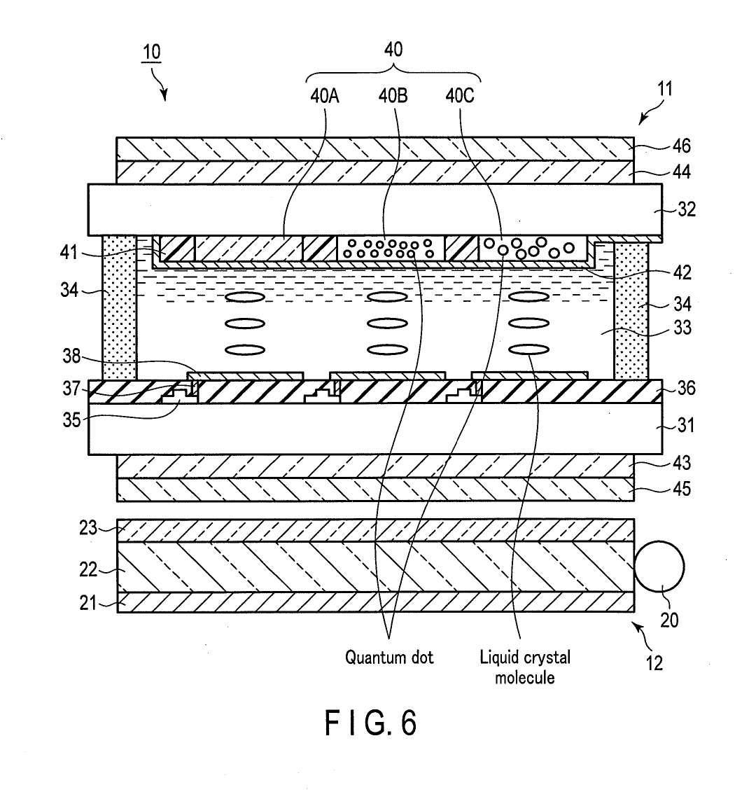

Next, a description will be given of the structure of a liquid crystal display according to the first embodiment. FIG. 6 is a sectional view of the liquid crystal display 10 of the first embodiment. The liquid crystal display 10 includes a display panel 11 and a light source unit (backlight) 12.

The backlight 12 is, for example, a side-light type (edge-light type) illumination device. The backlight 12 includes a reflective sheet 21, a light-guide plate 22 and a diffusion sheet 23, which are stacked in the order mentioned. The backlight 12 also includes a light-emitting element 20 arranged on a side of the light-guide plate 22. The diffusion sheet 23 may be provided with a prism sheet.

The light-emitting element 20 is an element that emits blue light. For example, the light-emitting element 20 is made of a single or a plurality of white light-emitting diodes (LEDs). The light emitted from the light-emitting element 20 is incident on a side surface of the light-guide plate 22 and is reflected by the reflective sheet 21. The light reflected by the reflective sheet 21 passes through the light-guide plate 22 and the diffusion sheet 23 and travels toward the display panel 11 as surface light.

The display panel 11 includes a first substrate 31 and a second substrate 32 which are arranged to face each other, and a liquid crystal layer 33 sandwiched between the first substrate 31 and the second substrate 32. Each of the first and second substrates 31 and 32 is made of a transparent substrate (e.g., a glass substrate). The first substrate 31 is arranged on the side closer to the light source unit 12, and the illumination light from the light source unit 12 enters the liquid crystal layer 33 from the first substrate 31. Of the two major surfaces of the display panel 11, the major surface which is opposite to the light source unit 12 is a display surface of the display panel 11.

The liquid crystal layer 33 is made of a liquid crystal material sealed by a seal member 34, by which the first substrate 31 and the second substrate 32 are pasted. The region surrounded by the seal member 34 is the display area of the display panel 11. The optical characteristics of the liquid crystal material vary when the alignment of the liquid crystal molecules is controlled in accordance with the electric field applied between the first substrate 31 and the second substrate 32. Various liquid crystal modes can be used, including the vertical alignment (VA) mode, the twisted nematic (TN) mode, and homogeneous mode.

The seal member 34 is formed, for example, of an ultraviolet curing resin, a thermosetting resin or a UV/heat combination type curing resin. In the manufacturing process, the resin is coated on the first substrate 31 or the second substrate 32, and is cured by ultraviolet irradiation or heating.

The display panel 11 is provided with a plurality of pixels. In FIG. 6, only three pixels are selectively shown for simplicity, but in actuality a plurality of pixels are arranged in a matrix pattern. On that side of the first substrate 31 which is closer to the liquid crystal layer 33, switching elements 35 are provided at positions corresponding to the pixels. Each switching element 35 is, for example, a thin film transistor (TFT) or an n-channel TFT. The TFT includes a gate electrode, a gate insulating film provided on the gate electrode, a semiconductor layer (e.g., an amorphous silicon layer) provided on the gate insulating film, and a source electrode and a drain electrode provided on the semiconductor layer. A detailed illustration of the TFT is omitted.

The switching element 35 is overlaid with an insulating layer 36. A pixel electrode 38 is provided on the insulating layer 36 at a position corresponding to each pixel. The pixel electrode 38 is provided entirely in the pixel region. The pixel electrode 38 is electrically connected by way of a contact 37 to one end (the drain electrode) of the current path of the switching element 35. The other end (source electrode) of the current path of the switching element 35 is electrically connected to a signal line used for supplying a pixel voltage (driving voltage). The gate electrode of the switching element 35 is electrically connected to a scanning line.

An alignment film (not shown) for controlling the alignment of the liquid crystal layer 33 is provided on the pixel electrode 38 and the insulating layer 36.

A wavelength conversion unit 40 is provided on that side of the second substrate 32 which is closer to the liquid crystal layer 33. The wavelength conversion unit 40 performs conversion of the wavelength of the light (blue light) transmitted through the liquid crystal layer 33 and outputs blue light, green light and red light. Each of the blue light, green light and red light is single-color light of a predetermined wavelength band. The wavelength band of the blue light is approximately 420 nm to 495 nm. The wavelength band of the green light is approximately 495 nm to 570 nm. The wavelength band of the red light is approximately 600 nm to 700 nm. In the present specification, the numeral ranges expressed by using “to” include values immediately before and after “to” as lower and upper limits.

Pixels are pixels of light's three primary colors, namely, red (R), green (G) and blue (B). An adjacent set of pixels of R, G and B colors functions as a unit of display (a pixel). Each of the single-color portions of one pixel is a minimum drive unit referred to as a sub pixel (sub picture element). The element 35 and the pixel electrode 38 are provided for each sub pixel. In the descriptions below, the sub pixels will be referred to simply as pixels, provided that the pixels and the sub pixels do not have to be discriminated from each other.

The wavelength conversion unit 40 includes a plurality of members provided in correspondence to the pixels. To be specific, the wavelength conversion unit 40 includes a transmission layer 40A for outputting blue light, wavelength conversion layer 40B for outputting green light and wavelength conversion layer 40C for outputting red light.

The transmission layer 40A is a transparent member including no quantum dot. The transmission layer 40A receives blue light from the backlight 12 and permits it to pass therethrough without conversion of the wavelength. The transmission layer 40A is made, for example, of acrylic resin.

Wavelength conversion layer 40B contains a plurality of quantum dots. For example, wavelength conversion layer 40B is formed by mixing the quantum dots in acrylic resin used as a basic material. Wavelength conversion layer 40B converts the wavelength of the blue light emitted from the backlight 12 into a wavelength of green light. That is, the quantum dots of wavelength conversion layer 40B have such a diameter d as enables conversion of the wavelength of blue light into the wavelength of green light.

Wavelength conversion layer 40C contains a plurality of quantum dots. Wavelength conversion layer 40C converts the wavelength of the blue light emitted from the backlight 12 into a wavelength of red light. That is, the quantum dots of wavelength conversion layer 40C have such a diameter d as enables conversion of the wavelength of blue light emitted from the backlight 12 to the wavelength of red light.

A black mask for shielding light (light-shielding film) 41 is provided on the second substrate 32 and on the boundaries between the adjacent pixels. The black mask 41 is arranged between the transmission layer 40A, wave conversion layer 40B and wavelength conversion layer 40C. The black mask 41 is formed in a lattice pattern and approximately covers the regions other than the pixel regions. The black mask 41 serves to shield the unwanted light between the adjacent pixels of different colors and to enhance the contrast.

A common electrode 42 is provided on the wavelength conversion unit 40 and the black mask 41. The common electrode 42 as a planar electrode is provided entirely in the display area.

An alignment film (not shown) for controlling the alignment of the liquid crystal layer 33 is provided on the common electrode 42.

The display panel 11 includes retardation plates 43 and 44 and polarizers 45 and 46. Retardation plates 43 and 44 are provided such that they sandwich the first substrate 31 and the second substrate 32. Polarizers 45 and 46 are provided such that they sandwich the retardation plates 43 and 44.

In the plane perpendicular to the light traveling direction, polarizers 45 and 46 have a transmission axis and an absorption axis perpendicular to each other. Of the light whose oscillation planes are in random directions, the linearly-polarized light (linearly-polarized components of light) having oscillation planes parallel to the transmission axis are allowed to pass through polarizers 45 and 46, while the linearly-polarized light (linearly-polarized components of light) having oscillation planes parallel to the absorption axis are absorbed by polarizers 45 and 46. Polarizers 45 and 46 are arranged, with their transmission axes being perpendicular to each other. That is, the polarizers 45 and 46 are arranged in the orthogonal nicol state.

Retardation plates 43 and 44 have refractive index anisotropy, and in the plane perpendicular to the light traveling direction they have a slow axis and a fast axis perpendicular to each other. Retardation plates 43 and 44 have the function of providing a predetermined retardation between the light of predetermined wavelength that has passed through the slow axis and the light of predetermined wavelength that has passed through the fast axis (the retardation is a phase difference of X/4 provided that the wavelength of the light is X). That is, retardation plates 43 and 44 are X/4 plates. Retardation plates 43 and 44 have the function of changing linearly polarized light into circularly polarized light and changing circularly polarized light into linearly polarized light.

Retardation plates 43 and 44 are arranged such that their slow axes are perpendicular to each other. The slow axis of retardation plate 43 is set to form approximately 45° with respect to the absorption axis of polarizer 45. The slow axis of retardation plate 44 is set to form approximately 45° with respect to the absorption axis of polarizer 46. The angles mentioned above in connection with the polarizers and retardation plates may include errors caused for attaining desirable operations and errors attributable to the manufacturing process. For example, the above-mentioned angle of approximately 45° is assumed to include an angle range of 45°±5°. In addition, being “perpendicular” is assumed to include an angle range of 90°+5°.

The pixel electrode 38, the contact 37 and the common electrode 42 are transparent electrodes and are formed, for example, of indium tin oxide (ITO). The insulating layer 36 is made of a transparent insulating material; it is formed of silicon nitride (SiN), for example. The black mask 41 is a laminated film including chromium oxide and chromium stacked in order; alternatively, the black mask 65 is made of black resin.

### [3] Operation

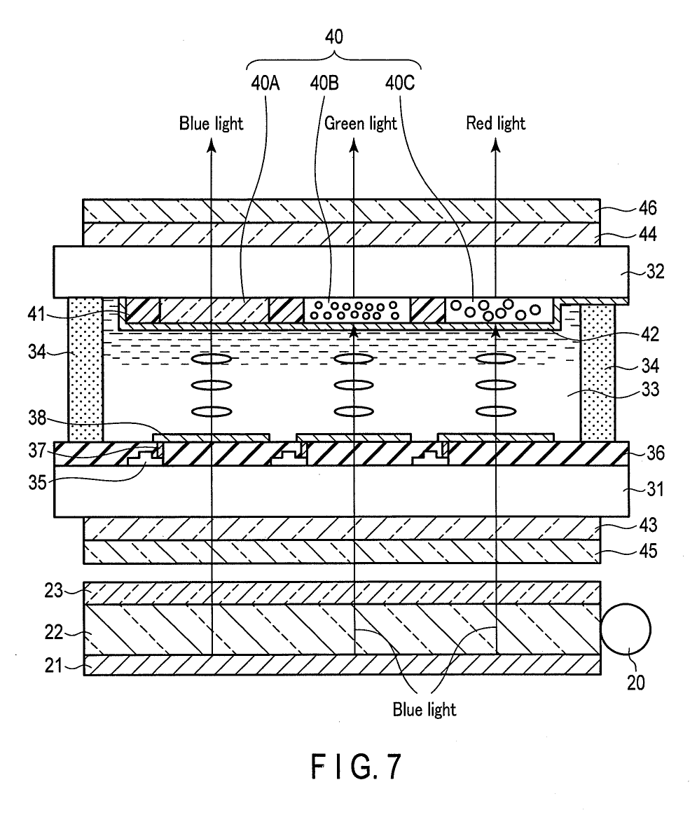

Next, a description will be given as to how the liquid crystal display 10 having the above structure operates. FIG. 7 illustrates how the liquid crystal display 10 of the first embodiment operates.

The backlight 12 emits blue light (λ≈455 nm) as illumination light. The blue light emitted from the backlight 12 is changed into circularly polarized light by polarizer 45 and retardation plate 43 and is incident on the liquid crystal layer 33. In the liquid crystal layer 33, the phase difference of each of the pixels is controlled in accordance with a display image. The blue light having transmitted through the liquid crystal layer 33 is incident on the wavelength conversion unit 40. The wavelength conversion unit 40 is provided with the transmission layer 40A, wavelength conversion layer 40B and wavelength conversion layer 40C.

The transmission layer 40A does not contain quantum dots and permits the blue light to output therefrom without conversion of the wavelength of the blue light.

Wavelength conversion layer 40B contains a plurality of quantum dots that change the wavelength of the blue light into the wavelength of green light. Accordingly, wavelength conversion layer 40B changes the wavelength of blue light into the wavelength of green light, and permits the green light to output therefrom. To be specific, the blue light incident on the quantum dots of wavelength conversion layer 40B is converted into the green light.

Wavelength conversion layer 40C contains a plurality of quantum dots that change the wavelength of the blue light into the wavelength of red light. Accordingly, wavelength conversion layer 40C changes the wavelength of blue light into the wavelength of red light, and permits the red light to output therefrom. To be specific, the blue light incident on the quantum dots of wavelength conversion layer 40C is converted into the red light.

Subsequently, the display light having passed through the wavelength conversion unit 40 (including blue light, green light and red light) is changed into linearly polarized light by retardation plate 44 and polarizer 46, and is recognized by the observer. In the manner described above, the liquid crystal display 10 can perform color display, using the blue light emitted from the backlight 12.

The liquid crystal display 10 can generate white light by mixing the blue light output from the transmission layer 40A, the green light output from wavelength conversion layer 40B and the red light output from wavelength conversion layer 40C. The color purity of this white light is determined by the density of the quantum dots contained in wavelength conversion light 40B and the density of the quantum dots contained in wavelength conversion layer 40C. Desirably, the densities of the quantum dots should be controlled in such a manner as to improve the color purity.

### [4] Advantages

As detailed above, in the first embodiment, the liquid crystal display 10 comprises a light source unit 12 for emitting blue light and a display panel 11 for receiving the blue light emitted from the light source unit 12. The display panel 11 includes a first substrate 31 opposed to the light source unit 12, a second substrate 32 arranged to face the first substrate 31, a liquid crystal layer 33 sandwiched between the first substrate 31 and the second substrate 32, and a wavelength conversion unit 40 provided on the second substrate 32, controlling the wavelength of the blue light having passed through the liquid crystal layer 33, and containing quantum dots. The wavelength conversion unit 40 is provided with a transmission layer 40A, wavelength conversion layer 40B and wavelength conversion layer 40C. The transmission layer 40A does not contain quantum dots and permits the blue light to pass therethrough. Wavelength conversion layer 40B contains quantum dots and converts the blue light into green light. Wavelength conversion layer 40C contains quantum dots and converts the blue light into red light.

According to the first embodiment, therefore, green light and red light having wavelengths greater than that of blue light can be generated using the blue light having a short wavelength (having high energy). In this manner, color display can be performed without using color filters. In addition, the liquid crystal display 10 can efficiently utilize the illumination light emitted from the light source 12.

Since the color filters are not used, the optical loss can be reduced. Accordingly, the power consumption can be reduced, and brighter display is enabled.

Moreover, since the blue light, green light and red light output from the liquid crystal display 10 are not dependent on color filters, the color purity of each single-color light can be enhanced. Accordingly, the color reproducibility of the liquid crystal display 10 can be improved.

### Second Embodiment

The second embodiment is an embodiment in which the color purities of green light and red light output from a wavelength conversion unit 40 are improved further.

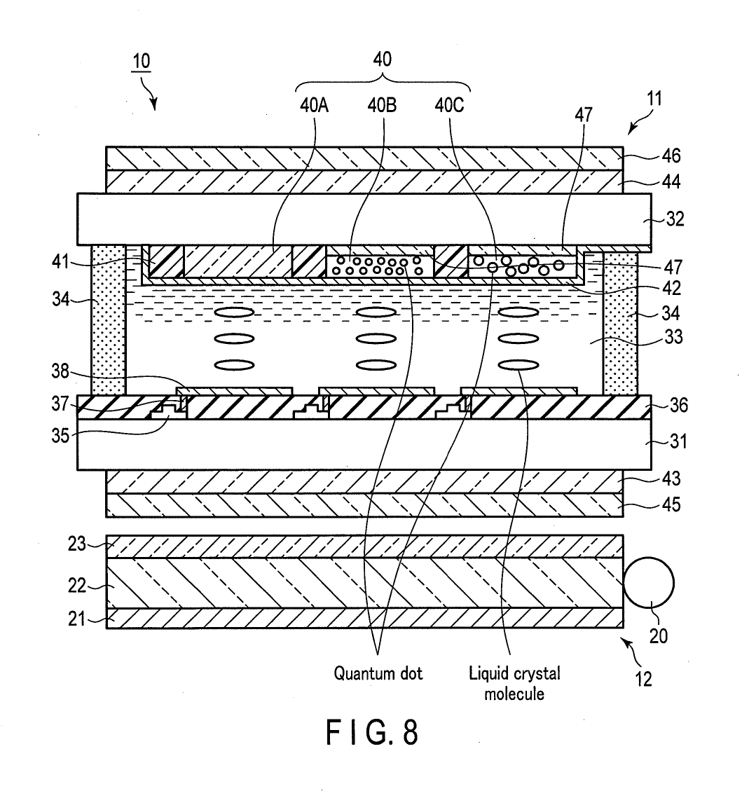

FIG. 8 is a sectional view of a liquid crystal display 10 of the second embodiment. The wavelength conversion unit 40 is provided with filter layers 47 provided in correspondence to the respective wavelength conversion layers 40B and 40C. One of the filter layers 47 is provided on the light output surface of wavelength conversion layer 40B (i.e., on the major surface on the display surface side). Likewise, the other filter layer 47 is provided on the light output surface of wavelength conversion layer 40C (i.e., on the major surface on the display surface side).

The filter layers 47 have the function of attenuating (or absorbing) blue light. The filter layers 47 are, for example, yellow filters formed by mixing yellow pigment, which is a coloring material, with transparent resin. The other features of the second embodiment are similar to those of the first embodiment.

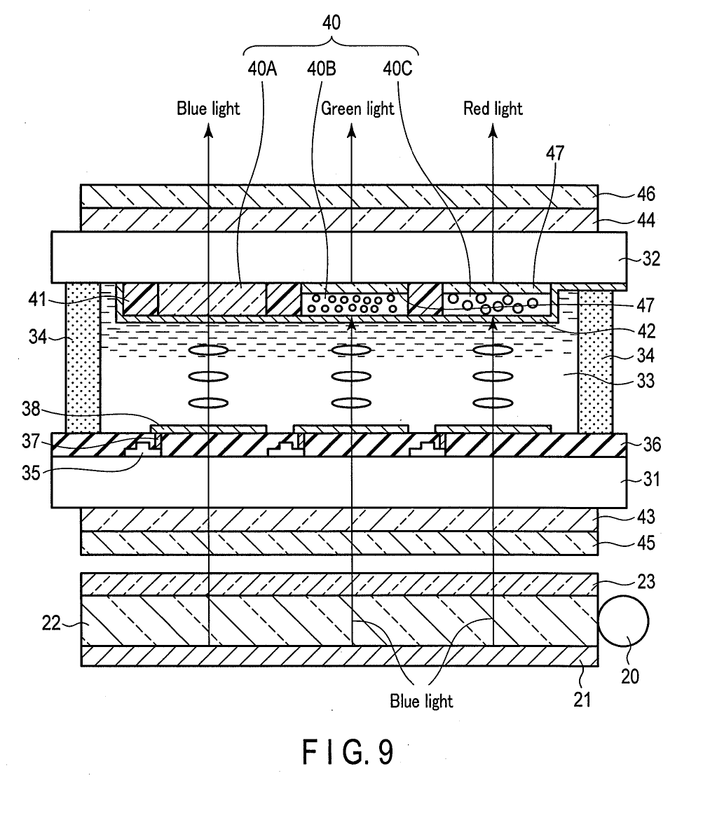

FIG. 9 illustrates how the liquid crystal display 10 of the second embodiment operates. The blue light incident on wavelength conversion layer 40B is converted into green light, and those components of the blue light that are not converted into the green light are attenuated by the filter 47. Likewise, the blue light incident on wavelength conversion layer 40C is converted into red light, and those components of the blue light that are not converted into the red light are attenuated by the filter 47.

According to the second embodiment, therefore, the color purities of the green light and red light output from the liquid crystal display 10 can be improved. Accordingly, the color reproducibility of the liquid crystal display 10 can be improved, and the image quality can also be improved. The other features of the second embodiment are similar to those of the first embodiment.

In the present specification, the terms “plate” and “film” are exemplary expressions of members and do not limit the structures of the members. For example, the retardation plates are not limited to plate-like members;

they may be films or any other types of members having the function described in the specification. The polarizers are not limited to plate-like members; they may be films or any other types of members having the function described in the specification.

The liquid crystal display of each of the foregoing embodiments is applicable to various electronic devices having the image display function. For example, the liquid crystal display can be applied to a mobile device (such as a mobile phone, a mobile information terminal, a smartphone or a tablet terminal), a game console, a notebook personal computer (PC), a television set, a digital video camera, a digital still camera, a scanner, etc.

The present invention is not limited to the above-mentioned embodiments, and can be reduced to practice by modifying the constituent elements without departing from the spirit and scope of the invention. In addition, the above-described embodiments include inventions of various stages, and a variety of inventions can be derived by properly combining structural elements of one embodiment or by properly combining structural elements of different embodiments. For example, if the object of the invention is achieved and the advantages of the invention are attained even after some of the structural elements disclosed in connection with the embodiments are deleted, the structure made up of the resultant structural elements can be extracted as an invention.

What is claimed is:

1. A liquid crystal display comprising:
a light source unit which emits blue light;
a first substrate opposed to the light source unit;
a second substrate arranged to face the first substrate;
a liquid crystal layer provided between the first substrate and the second substrate; and
a wavelength conversion unit provided on the second substrate, controlling a wavelength of blue light having passed through the liquid crystal layer, and including quantum dots.

2. The liquid crystal display according to claim 1, wherein
the wavelength conversion unit comprises a first layer, a second layer and a third layer which are provided in correspondence to respective pixels,
the first layer does not contain quantum dots and permits the blue light to pass therethrough,
the second layer contains quantum dots and changes the blue light into green light, and
the third layer contains quantum dots and changes the blue light into red light.

3. The liquid crystal display according to claim 2, further comprising:
a first filter provided on a light-output major surface of the second layer and attenuating the blue light; and
a second filter provided on a light-output major surface of the third layer and attenuating the blue light.

4. The liquid crystal display according to claim 3, wherein each of the first and second filters includes yellow pigment.

5. The liquid crystal display according to claim 2, wherein the quantum dots of the second layer have a diameter smaller than that of the quantum dots of the third layer.

6. The liquid crystal display according to claim 2, wherein a density of the quantum dots of the second layer and a density of the quantum dots of the third layer are set such that light output from the first layer, light output from the second layer and light output from the third layer become white light when mixed together.

7. The liquid crystal display according to claim 1, further comprising:
a first polarizer and a second polarizer which are provided to sandwich the first substrate and the second substrate.

8. The liquid crystal display according to claim 1, further comprising:
pixel electrodes provided on the first substrate and provided in correspondence to pixels; and
a common electrode provided on the wavelength conversion unit.

9. The liquid crystal display according to claim 8, further comprising:
switching elements provided on the first substrate and electrically connected to the pixel electrodes.

10. The liquid crystal display according to claim 2, comprising:
a light-shielding film provided between the first layer, the second layer and the third layer.
